(19) United States
(12) Patent Application Publication
(10) Pub. No.: US 2023/0000290 A1
(43) Pub. Date: Jan. 5, 2023

(54) DRIVETRAIN FOR A MIXER

(71) Applicant: Haier US Appliance Solutions, Inc., Wilmington, DE (US)

(72) Inventor: Edward Simeon Chupka, Bardstown, KY (US)

(21) Appl. No.: 17/365,524

(22) Filed: Jul. 1, 2021

(51) Int. Cl. A47J 43/08; A47J 43/044; F16H 1/28; F16H 57/08

(52) U.S. Cl. CPC A47J 43/082; A47J 43/044; F16H 1/28; F16H 57/082; A47J 2043/04481

(57) ABSTRACT

A drivetrain for coupling a motor to a mixer shaft within a mixer includes a sun gear connectable to a rotor of the motor. The drivetrain also includes a plurality of stepped planetary gears. Each of the stepped planetary gears includes a first tooth section and a second tooth section. A first ring gear is mounted such that the first ring gear is fixed. The first ring gear and the sun gear are meshed with the stepped planetary gears at the first tooth section. A second ring gear is meshed with the stepped planetary gears at the second tooth section. The sun gear, the stepped planetary gears, the first ring gear, and the second ring gear collectively form a single stage planetary gear set of the drivetrain.

### FIELD OF THE INVENTION

The present disclosure relates generally to drivetrains for mixers, such as stand mixers.

### BACKGROUND OF THE INVENTION

Stand mixers generally include a motor and a drivetrain for connecting the motor to a mixer shaft. The drivetrain provides a mechanical advantage between the motor and the mixer shaft. Moreover, the drivetrain may increase a torque of the motor by decreasing the rotational speed of the motor. Known drivetrains can be large and difficult to assemble and thus negatively increase production time.

### BRIEF DESCRIPTION OF THE INVENTION

The present subject matter provides a single stage planetary gear set for a \ mixer drivetrain. The single stage planetary gear set may include a plurality of stepped planet gears. A sun gear and a first ring gear may be meshed with a first tooth section of the stepped planet gears, and a second ring gear may be meshed with second tooth section of the stepped planet gears. The single stage planetary gear set may advantageously be more compact as well be assembled more quickly and easily than a two stage or double planetary gear set. Aspects and advantages of the invention will be set forth in part in the following description, may be apparent from the description, or may be learned through practice of the invention.

In one example aspect, a stand mixer includes a base. A head is pivotally mounted to the base, a motor is disposed within the head, and a mixer shaft is rotatably mounted on the head. A drivetrain couples the motor to the mixer shaft such that the mixer shaft is rotatable by the motor. A single stage planetary gear set of the drivetrain includes a sun gear connected to a rotor of the motor. The single stage planetary gear set also includes a plurality of stepped planetary gears. Each of the stepped planetary gears includes a first tooth section and a second tooth section. A first ring gear is mounted to the head such that the first ring gear is fixed relative to the head. The first ring gear and the sun gear are meshed with the stepped planetary gears at the first tooth section. A second ring gear is meshed with the stepped planetary gears at the second tooth section.

In another example aspect, a drivetrain for coupling a motor to a mixer shaft within a mixer includes a sun gear connectable to a rotor of the motor. The drivetrain also includes a plurality of stepped planetary gears. Each of the stepped planetary gears includes a first tooth section and a second tooth section. A first ring gear is mounted such that the first ring gear is fixed. The first ring gear is meshed with the stepped planetary gears at the second tooth section. The drivetrain further includes a second ring gear. The second ring gear and the sun gear are meshed with the stepped planetary gears at the first tooth section. The sun gear, the stepped planetary gears, the first ring gear, and the second ring gear collectively form a single stage planetary gear set of the drivetrain.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a side, elevation view of a stand mixer according to an example embodiment of the present subject matter.

FIG. 2 is a schematic view of a drivetrain of the example stand mixer of FIG. 1.

FIG. 3 is a perspective view of the drivetrain of FIG. 2.

FIG. 4 is an exploded view of the drivetrain of FIG. 2.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a ten percent (10%) margin.

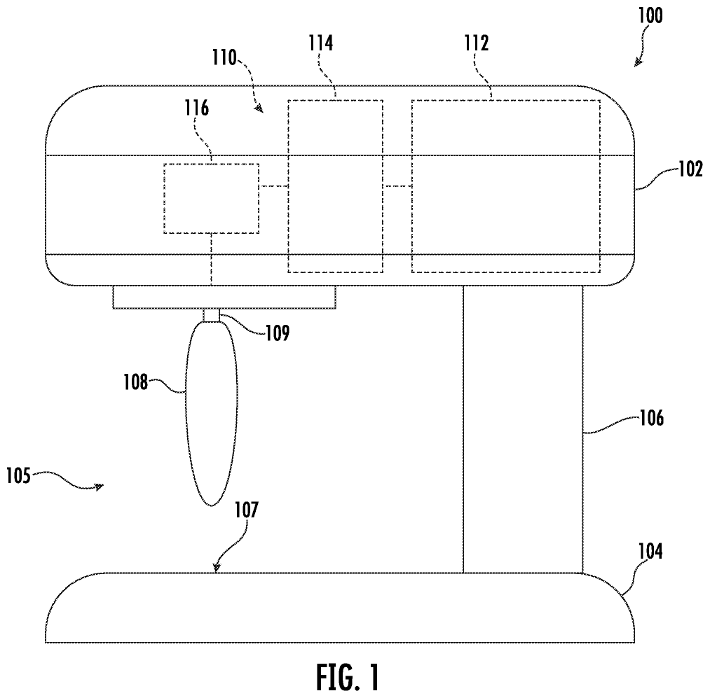

FIG. 1 provides a side, elevation view of a stand mixer 100 according to an example embodiment of the present subject matter. It will be understood that stand mixer 100 is provided by way of example only and that the present subject matter may be used in or with any suitable stand mixer in alternative example embodiments.

Stand mixer 100 includes a head 102 and a base 104. Head 102 houses various mechanical and/or electrical components of stand mixer 100 and thus may also be referred to herein as a casing. For example, as shown in FIG. 1, a motor 112, a planetary gear set 114, and a bevel gear set 116 may be disposed within head 102. Base 104 may support head 102. For example, head 102 may be pivotally mounted to base 104 on a post 106, e.g., that extends upwardly. Head 102 may be suspended over a mixing zone 105, within which a mixing bowl may be disposed.

A drivetrain 110 is disposed within head 102 and is configured for coupling a motor 112 to a mixer shaft 109, e.g., such that mixer shaft 109 is rotatable with motor 112 via drivetrain 110. Drivetrain 110 may include planetary gear set 114, bevel gear set 116, etc. Mixer shaft 109 may be positioned above mixing zone 105 on head 102, and an attachment 108, such as a beater, whisk, or hook, may be removably mounted to mixer shaft 109. Attachment 108 may rotate within a bowl (not shown) in mixing zone 105 to beat, whisk, kneed, etc. material within the bowl, during operation of motor 112.

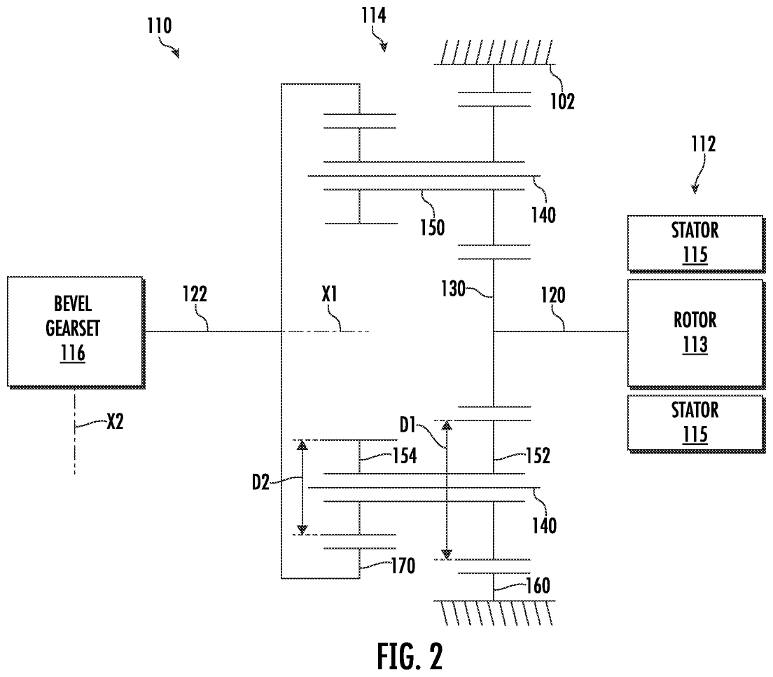

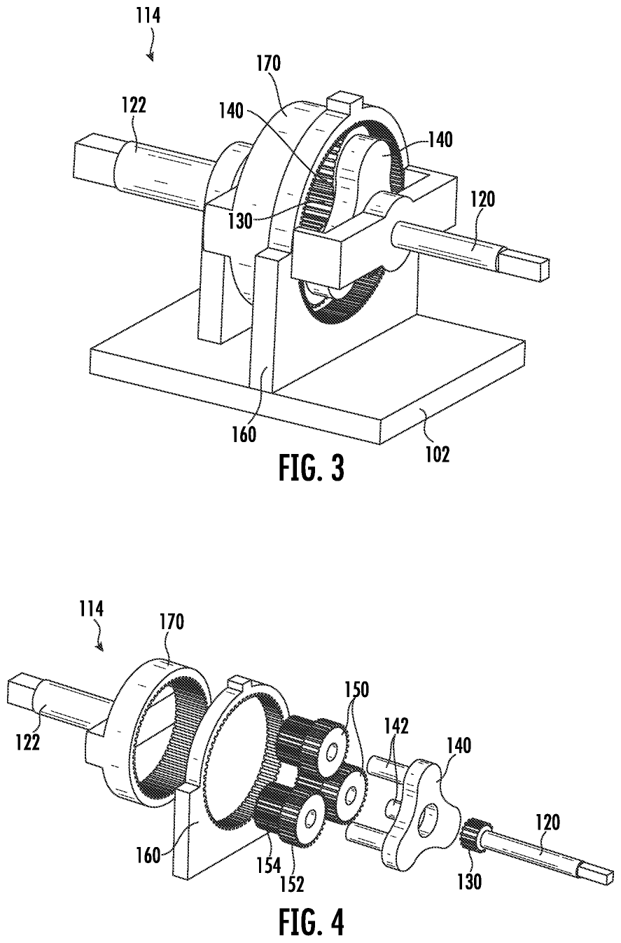

As noted above, motor 112 may be operable to rotate mixer shaft 109. Motor 112 may be a direct current (DC) motor in certain example embodiments. In alternative example embodiments, motor 112 may be an alternating current (AC) motor. As shown in FIG. 2, motor 112 may include a rotor 113 and a stator 115. Stator 115 may be mounted within head 102 such that stator 115 is fixed relative to head 102. A current through windings within stator 115 may generate a magnetic field that induces rotation of rotor 113, e.g., due to magnets on stator 115. Stator 115 may rotate at a relatively high rotational velocity and relatively low torque. Thus, drivetrain 110 may be configured to provide a rotational speed reduction and mechanical advantage between motor 112 and mixer shaft 109.

Planetary gear set 114 may include a sun gear 130, a plurality of stepped planetary gears 150, a first ring gear 160, and a second ring gear 170. Sun gear 130, stepped planetary gears 150, first ring gear 160, and second ring gear 170 may collectively form a single stage planetary gear set, e.g., such that planetary gear set 114 has a single input and a single output. Planetary gear set 114 may provide a suitable mechanical advantage. For instance, a gear ratio of planetary gear set 114 may be between 35:1 and 80:1. As another example, the gear ratio of planetary gear set 114 may be between 50:1 and 60:1. Such gear ratios may advantageously allow motor 112 to rotate attachment 108 at suitable speeds and with suitable torques.

Sun gear 130 may be connected to rotor 113 of motor 112. For instance, an input shaft 120 of drivetrain 110 may extend between and connect rotor 113 and sun gear 130. In alternative example embodiments, one or more additional shafts may be disposed in the power flow between motor 112 and sun gear 130. Due to input shaft 120 being connected to sun gear 130, sun gear 130 may correspond to an input for planetary gear set 114.

Each of stepped planetary gears 150 may include a first tooth section 152 and a second tooth section 154. An outside diameter D1 of first tooth section 152 may be greater than an outside diameter D2 of second tooth section 154. Moreover, first tooth section 152 and second tooth section 154 may each include a different number of teeth. For instance, first tooth section 152 may have more teeth than second tooth section 154 in certain example embodiments. Thus, stepped planetary gears 150 may also be referred to compound planetary gears. To engage with stepped planetary gears 150, first and second ring gears 160, 170 may have different inside diameters. First and second tooth sections 152, 154 may be spaced axially, e.g., along an axis of rotation, on stepped planetary gears 150. First and second tooth sections 152, 154 of each stepped planetary gear 150 may be fixed and not rotatable relative to each other. Stepped planetary gears 150 may be meshed with both first and second ring gears 160, 170 at a respective one of first and second tooth sections 152, 154, as discussed in greater detail below.

Planetary gear set 114 may also include a planet carrier 140. Stepped planetary gears 150 may be rotatably mounted on planet carrier 140. For example, planet carrier 140 may include a plurality of axles 142, and each of stepped planetary gears 150 may rotatably mounted on a respective one of axles 142. Input shaft 120 may extent through planet carrier 140, e.g., such that planet carrier 140 is rotatably mounted on input shaft 120.

Sun gear 130, stepped planetary gears 150, first ring gear 160, and second ring gear 170 may be formed of suitable materials, such as plastic or metal. In particular, each of stepped planetary gears 150 may be a single, unitary piece of material, such as plastic or metal. Thus, first and second tooth sections 152, 154 may be formed of or from the single, unitary piece of material in each stepped planetary gear 150.

First ring gear 160 may be fixed and non-rotatable. Thus, first ring gear 160 may be mounted to head 102 such that first ring gear 160 is fixed relative to head 102. First ring gear 160 may be fastened, adhered, shaped, or otherwise suitably fixed to head 102. First ring gear 160 and sun gear 130 may be meshed with stepped planetary gears 150 at first tooth section 152. Thus, e.g., first tooth section 152 of each stepped planetary gear 150 may extend between first ring gear 160 and sun gear 130. The external teeth of sun gear 130 may mesh with the teeth of each stepped planetary gear 150 at first tooth section 152, and the internal teeth of first ring gear 160 may mesh with the teeth of each stepped planetary gear 150 at first tooth section 152.

Second ring gear 170 may be meshed with stepped planetary gears 150 at second tooth section 154. Thus, e.g., internal teeth of second ring gear 170 may mesh with the teeth of each stepped planetary gear 150 at second tooth section 154. Drivetrain 110 may include an output shaft 122 connected to second ring gear 170. Moreover, output shaft 122 may extend between and connect second ring gear 170 and another component of drivetrain 110, such as a bevel gear of bevel gear set 116. Due to output shaft 122 being connected to second ring gear 170, second ring gear 170 may correspond to an output for planetary gear set 114.

In another example embodiment, e.g., when the outside diameter D1 of first tooth section 152 is less than the outside diameter D2 of second tooth section 154, first ring gear 160 may be meshed with stepped planetary gears 150 at second tooth section 154, and second ring gear 170 and sun gear 130 may be meshed with stepped planetary gears 150 at first tooth section 152.

Bevel gear set 116 may include bevel gears (not shown) that changes a rotational axis of power flow within drivetrain 110. For example, as shown in FIG. 2, output shaft 122 may rotate about a first axis X1, and a first bevel gear of bevel gear set 116 may be rotate about the first axis X1. A second bevel gear of bevel gear set 116 may be meshed with the first bevel gear of bevel gear set 116, and the second bevel gear of bevel gear set 116 may rotate about a second axis X2. As an example, the first axis X1 may be substantially horizontal, and the second axis X2 may be substantially vertical when motor 112 operates to rotate attachment 108 in mixing zone 105.

By utilizing planetary gear set 114, drivetrain 110 may provide a high reduction between motor 112 and mixer shaft 109 in a compact and easy to assemble design.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A stand mixer, comprising:
a base;
a head pivotally mounted to the base;
a motor disposed within the head;
a mixer shaft rotatably mounted on the head; and
a drivetrain coupling the motor to the mixer shaft such that the mixer shaft is rotatable by the motor, a single stage planetary gear set of the drivetrain comprising
a sun gear connected to a rotor of the motor,
a plurality of stepped planetary gears, each of the stepped planetary gears comprising a first tooth section and a second tooth section,
a first ring gear mounted to the head such that the first ring gear is fixed relative to the head, the first ring gear and the sun gear meshed with the stepped planetary gears at the first tooth section, and
a second ring gear meshed with the stepped planetary gears at the second tooth section.

2. The stand mixer of claim 1, wherein the stepped planetary gears are rotatably mounted on a planet carrier.

3. The stand mixer of claim 2, wherein each of the stepped planetary gears is rotatably mounted on a respective axle of the planet carrier.

4. The stand mixer of claim 1, wherein the drivetrain further comprises an input shaft extending between a rotor of the motor and the sun gear.

5. The stand mixer of claim 1, wherein the drivetrain further comprises an output shaft connected to the second ring gear.

6. The stand mixer of claim 5, wherein the drivetrain further comprises a bevel gear set, the output shaft extending between the second ring gear and a bevel gear of the bevel gear set.

7. The stand mixer of claim 1, wherein an outside diameter of the first tooth section is greater than an outside diameter of the second tooth section.

8. The stand mixer of claim 1, wherein a gear ratio of the single stage planetary gear set is between 35:1 and 80:1.

9. The stand mixer of claim 1, wherein each of the stepped planetary gears is a single, unitary piece of material.

10. A drivetrain for coupling a motor to a mixer shaft within a mixer, the drivetrain comprising:
a sun gear connectable to a rotor of the motor;
a plurality of stepped planetary gears, each of the stepped planetary gears comprising a first tooth section and a second tooth section;
a first ring gear mounted such that the first ring gear is fixed, the first ring gear and the sun gear meshed with the stepped planetary gears at the first tooth section; and
a second ring gear meshed with the stepped planetary gears at the second tooth section,
wherein the sun gear, the stepped planetary gears, the first ring gear, and the second ring gear collectively form a single stage planetary gear set of the drivetrain.

11. The drivetrain of claim 10, wherein the stepped planetary gears are rotatably mounted on a planet carrier.

12. The drivetrain of claim 11, wherein each of the stepped planetary gears is rotatably mounted on a respective axle of the planet carrier.

13. The drivetrain of claim 10, wherein the drivetrain further comprises an input shaft connected to the sun gear.

14. The drivetrain of claim 10, wherein the drivetrain further comprises an output shaft connected to the second ring gear.

15. The drivetrain of claim 10, wherein an outside diameter of the first tooth section is greater than an outside diameter of the second tooth section.

16. The drivetrain of claim 10, wherein a gear ratio of the single stage planetary gear set is between 35:1 and 80:1.

17. The drivetrain of claim 10, wherein each of the stepped planetary gears is a single, unitary piece of material.

18. A drivetrain for coupling a motor to a mixer shaft within a mixer, the drivetrain comprising:
a sun gear connectable to a rotor of the motor;
a plurality of stepped planetary gears, each of the stepped planetary gears comprising a first tooth section and a second tooth section;
a first ring gear mounted such that the first ring gear is fixed, the first ring gear meshed with the stepped planetary gears at the second tooth section; and
a second ring gear, the second ring gear and the sun gear meshed with the stepped planetary gears at the first tooth section,
wherein the sun gear, the stepped planetary gears, the first ring gear, and the second ring gear collectively form a single stage planetary gear set of the drivetrain.

19. The drivetrain of claim 18, wherein an outside diameter of the second tooth section is greater than an outside diameter of the first tooth section.
